(19) United States
(12) Patent Application Publication
(10) Pub. No.: US 2017/0334496 A1
(43) Pub. Date: Nov. 23, 2017

(54) VARIABLE-ATTITUDE SYSTEM FOR STABILISER WHEELS FOR BICYCLES AND MINI MOTORBIKES

(71) Applicant: MONTECARLO LOOK S.R.L., San Zeno Naviglio (IT)

(72) Inventor: ANDREA DI VITTO, BRESCIA (IT)

(73) Assignee: MONTECARLO LOOK S.R.L., San Zeno Naviglio (IT)

(21) Appl. No.: 15/538,322

(22) PCT Filed: Dec. 22, 2015
(86) PCT No.: PCT/IB2015/059884

§ 371 Date: Jun. 21, 2017

(30) Foreign Application Priority Data
Dec. 23, 2014 (IT) BS2014A000217

(51) Int. Cl. B62H 1/12; B62H 7/00

(52) U.S. Cl. CPC B62H 1/12; B62H 7/00

(57) ABSTRACT

A variable-attitude system is applicable to the wheels for children's bicycles and mini motorbikes, essential in the early learning phase, and facilitates and speeds up correct use. The mechanism described allows progressively reducing the balance support provided by the I, supplementary wheels (3) by adjusting the pressure of a spring (8). Moreover, the wheels (3) can be eliminated, much earlier and gradually, by moving upwards a stop pin (6) or screw that raises the arm (2) that supports them, moving them progressively away from the running plane (12).

This invention relates to a variable-attitude system applicable to stabiliser wheels for bicycles and mini motorbikes for children, particularly useful for acquiring balance and riding autonomy of such vehicles.

As is known, learning to ride two-wheeled vehicles is one of the milestones to be achieved in a child's life. Although, once learned, riding such vehicles is, in itself, relatively simple, in the early stages of learning it is very difficult because of the delicate balance that the child must learn to manage.

One of the methods that allow learning to ride two-wheeled vehicles consists of applying one or two stabiliser wheels to the sides of the rear wheel that provide secure support on at least three wheels. This allows the child to learn the movements of pedalling, steering and braking while avoiding the risk of falling.

However, the presence of stabiliser wheels does not help in acquiring a sense of balance, since the child almost never perceives the feeling of “loss of balance” and he is not brought to compensate for it.

Systems are known in the art that comprise elastic springs arranged between the bicycle frame and the arms of the stabiliser wheels so as to allow the wheels to adapt to the conditions of the terrain. There are also systems that allow raising the stabiliser wheels from the ground using suitable articulated mechanical systems without necessarily having to dismantle them.

Some of the previously mentioned solutions are, for example, described in documents U.S. Pat. No. 6,331,012B1, U.S. Pat. No. 3,746,367A, EP0911248A2, EP1232937A1, EP0127425A1, U.S. Pat. No. 7,641,213B1, U.S. Pat. No. 5,352,403A, CN2261376Y and DE29704203U1. However, there are only rare examples of systems capable of helping the gradual learning of riding two-wheeled vehicles using variable-attitude stabiliser wheels. An example of a gradual learning system is described in document WO2014/009925A1 in the name of the same applicant.

Inconveniently, the systems of the prior art are poorly adaptable to the riding characteristics of the child, which change over time, as riding skill improves. One of the purposes of this invention is to overcome the limitations of the stabiliser wheels of the prior art, improving the adaptability of the support provided by the wheels based on the riding style of the child, while making a simplicity of use of the system by a non-expert operator.

According to the invention, this purpose is achieved by a variable-attitude system applicable to stabiliser wheels according to claim 1.

Such a variable-attitude system, intended mainly for children's bicycles and mini motorbikes, is constituted by two metal arms, joined by a hinge joint and by elastic means. The system is also constituted by a stop pin with spheres or cotter or screw pin, and on the two sides of one of the two arms there are holes that allow the progressive shifting of the pin with spheres or cotter or screw pin, for the gradual raising of the wheel from the running plane.

Preferred embodiments of the invention are defined in the dependent claims.

Preferably, the two arms are joined by a threaded-screw adjusting pin provided with threaded support, anchored to the joint by means of a support. The threaded-screw is also anchored to one of two arms through a hole.

Preferably, in said holes on the arm is inserted the pin with spheres or cotter or screw pin for the gradual raising of the wheel from the running plane, by repositioning of the pin.

Preferably, a threaded-screw adjusting pin allows the modulation of the pressure of a double torsion spring on the arm, by varying the distance of the two ends of said spring from the surface of the arm.

In addition, preferably, the presence on the threaded-screw adjusting pin of a specially designed support allows an interlocking support of the ends of the double torsion spring to facilitate the excursion upwards, to increase the pressure of the spring on the arm, and downwards upon the decrease of the pressure of the spring on the arm.

Preferably, the system comprises a support suitable to stabilise the vertical position of the threaded-screw adjusting pin by anchoring it to the hinge joint.

In an embodiment, for adjusting the pressure of the wheel on the running plane, the system comprises a bellows adjustment support with a compression spring and a threaded nut integrated into the bellows adjustment support.

Preferably, the threaded adjustment pin allows the excursion of the bellows adjustment support. In addition, on the threaded adjustment pin, a sliding support slides along the pin and allows adjusting the pressure on the arm.

Preferably, two arm segments provide sliding support to the two arms.

In addition, a mobile support secures, at the base, the threaded adjusting pin to the joint allowing it to oscillate integrally with the arm.

The characteristics and advantages of the variable-attitude system according to this invention will be apparent from the following description, given by way of non-limiting example, in accordance with the accompanying drawings, in which:

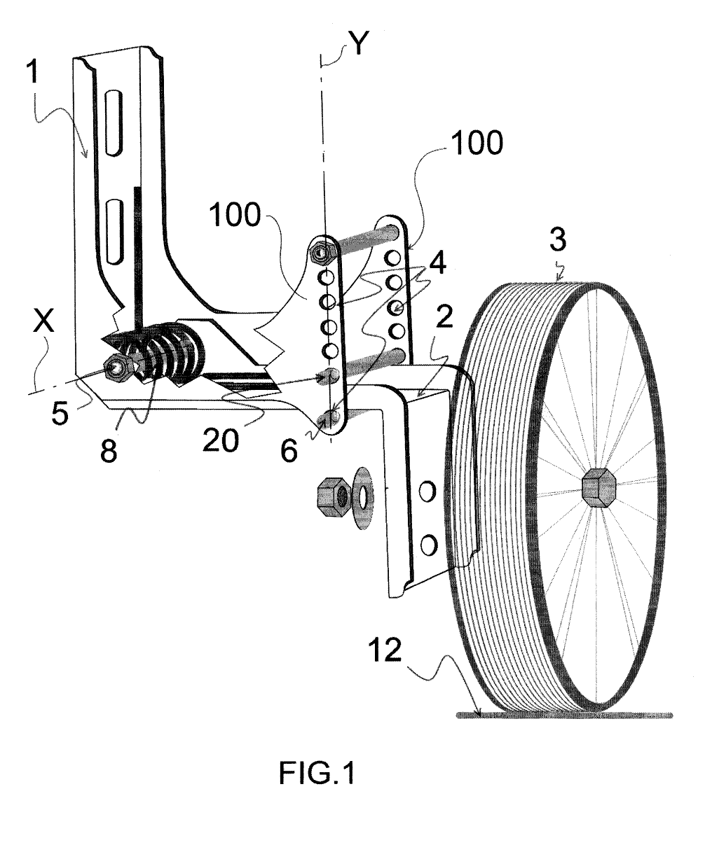

FIG. 1 is a schematic view of the system according to a first embodiment of this invention;

FIGS. 1a to 1c are side views of the system according to the embodiment in FIG. 1, in which each view represents a different configuration of the wheel arm that supports the wheel;

FIG. 1d is a schematic perspective view of the system according to a second embodiment of this invention;

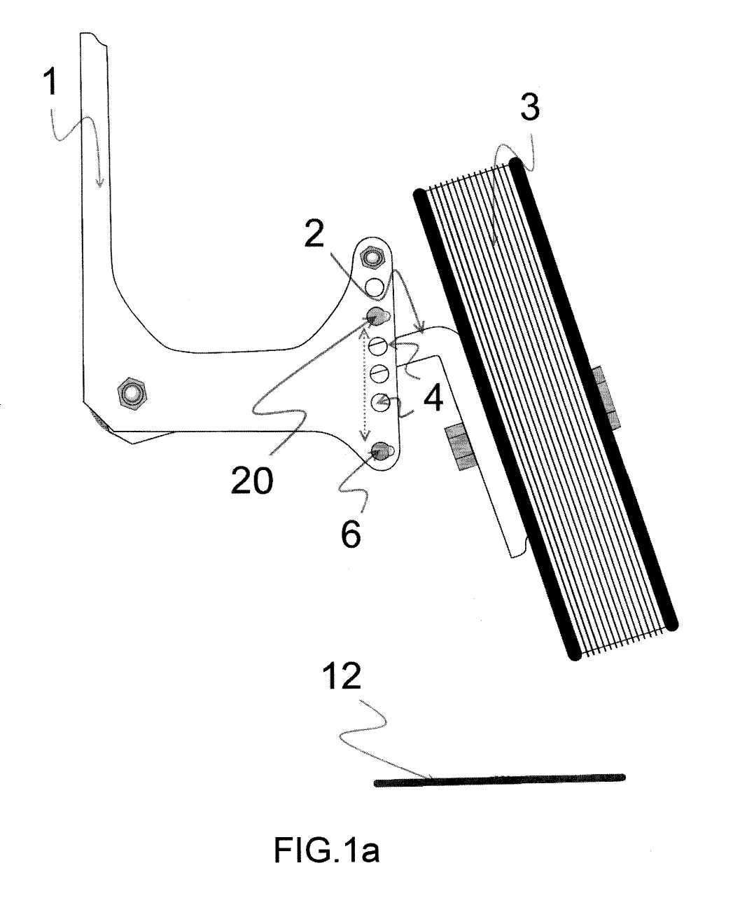

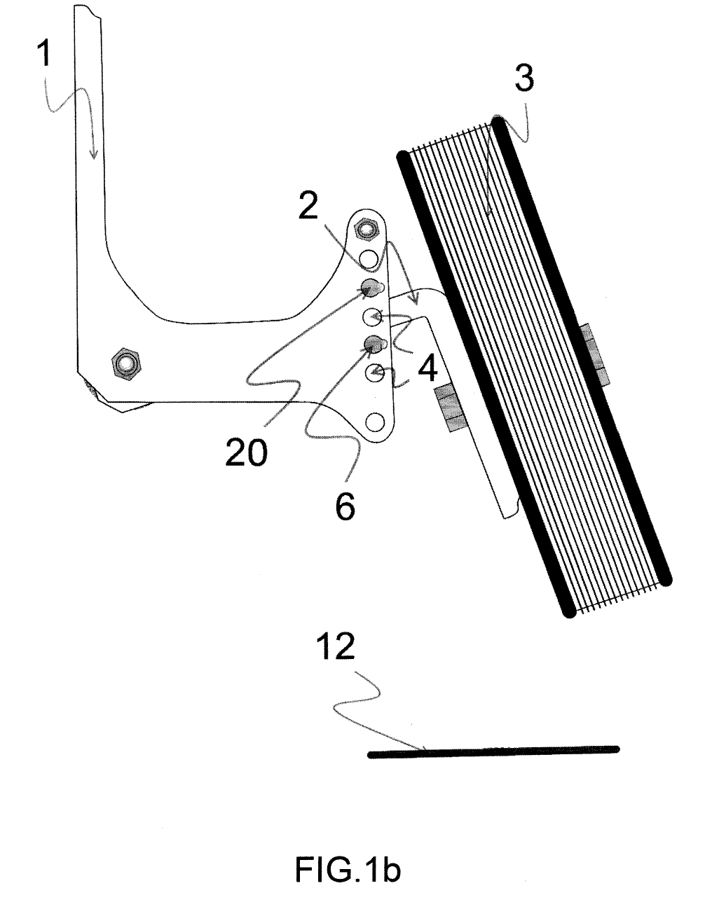

FIG. 2 and FIG. 3 are side views of the system in FIG. 1d, respectively, in a first configuration and in a second configuration;

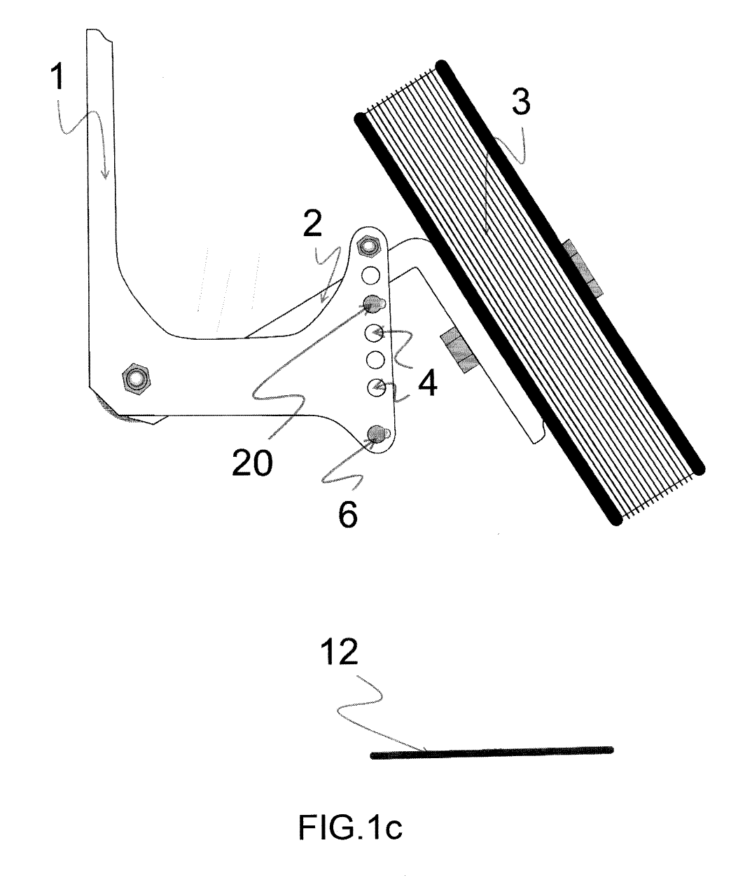

FIG. 4 is a schematic perspective view of the system according to a third embodiment of this invention;

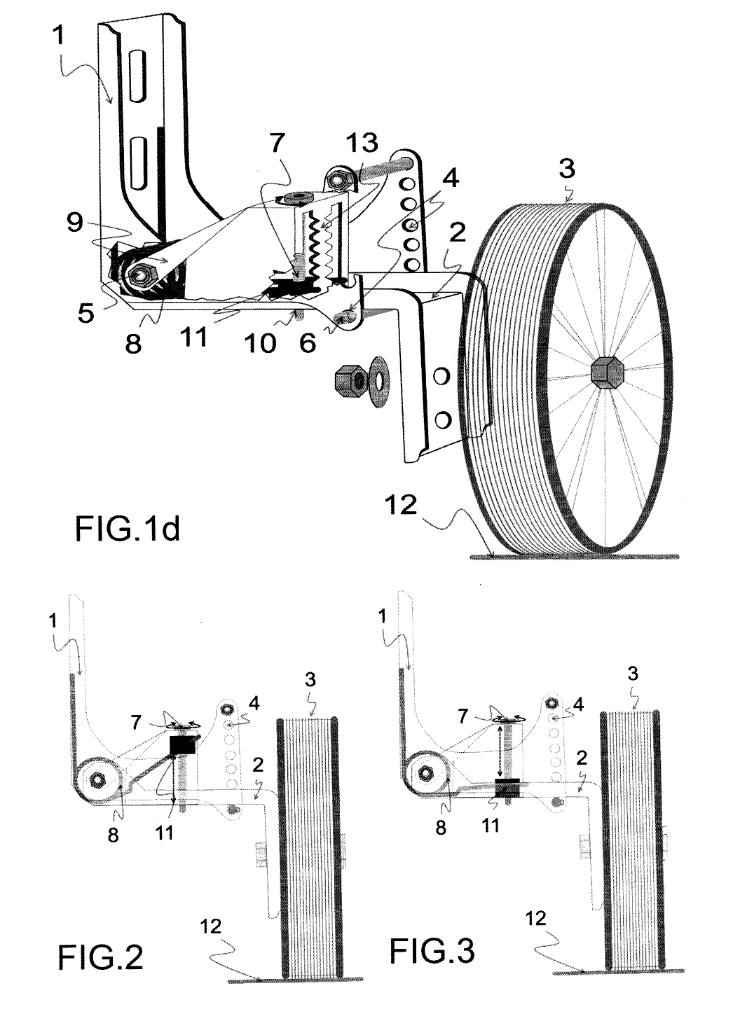

FIG. 5 is a schematic perspective view of the system according to the embodiment of FIG. 4 in a different configuration, with compression spring more compressed;

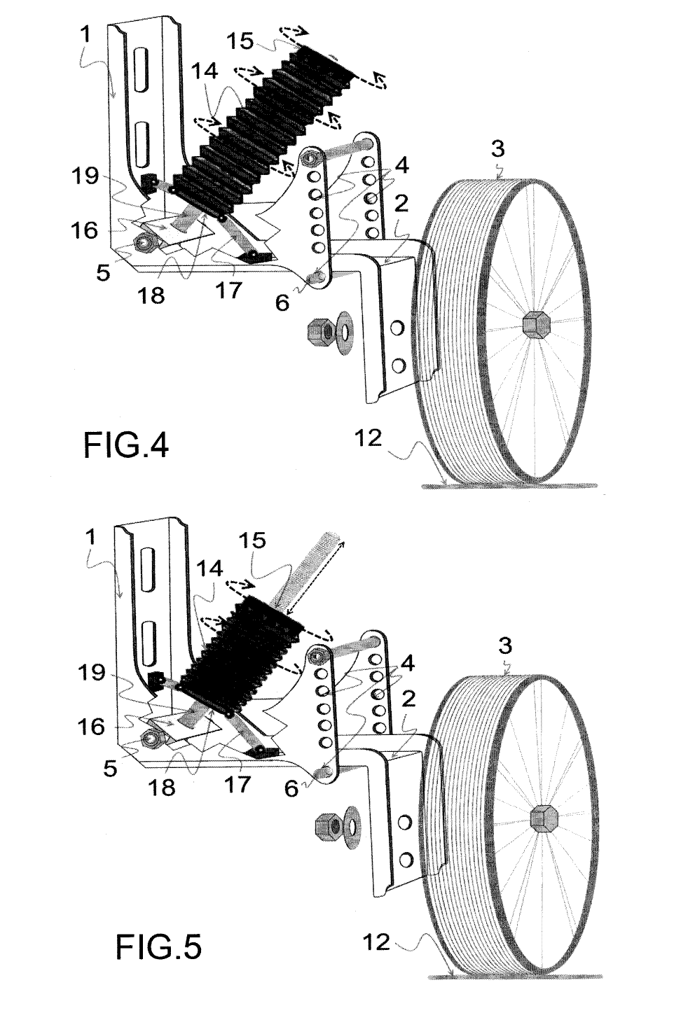

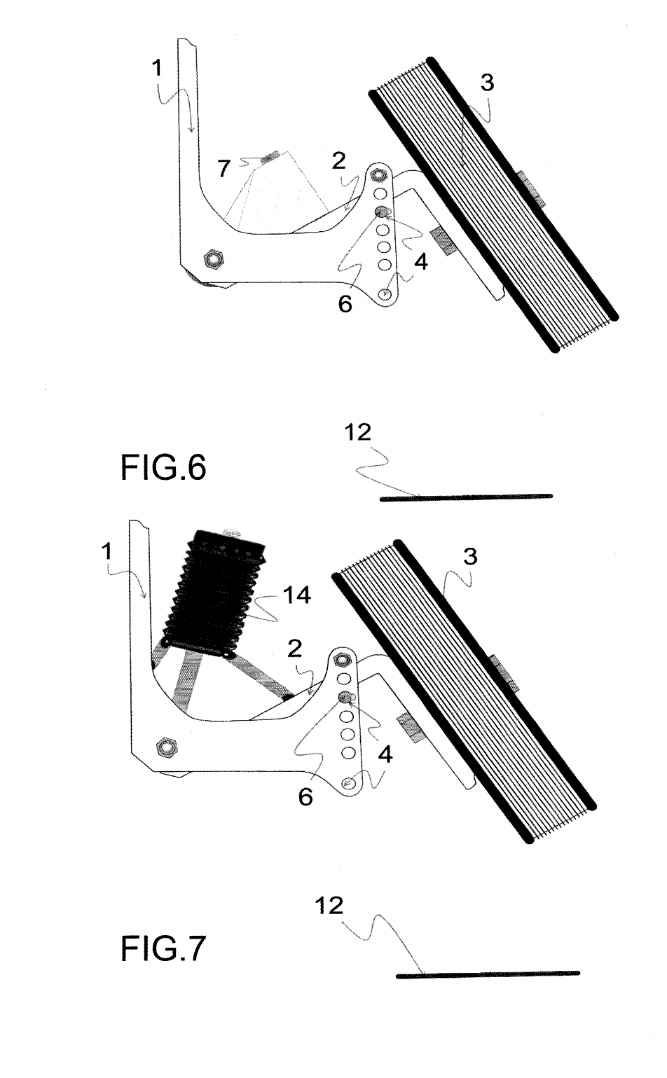

FIG. 6 and FIG. 7 are schematic side views of the system, respectively, according to the embodiment of FIG. 1d and according to the embodiment illustrated in FIG. 4, in a further position of the wheel arm (wheel in a fully raised position).

According to the accompanying drawings, the system of this patent application is designed to be applied to stabiliser wheels for children's bicycles and mini motorbikes present on the market. This solution differs from fixed stabilisers for bicycles and mini motorbikes in the market for two characteristics: the ability to adjust, by appropriately moving the stop pin with spheres or cotter or screw pin 6 inserted in the holes 4 (adjustment holes) on a first arm 1 (or frame arm 1), the inclined position of a second arm 2 (or wheel arm 2) where the wheel 3 houses and the ability to adjust, at the same time through the use of elastic means 8 (FIG. 1), the amount of support that the wheel itself must provide during operation. These are characteristics provided by innovative adjustment systems, described below, that also differentiate this invention from existing systems provided with adjustment. The mechanisms described here allow gradually adapting the support from the stabiliser wheels, necessary during the use of bicycles in the learning phase, to the skill level of the child using it. Broadly, the adjustment system is composed in such a way that, unlike existing systems, the support arm of the wheels (the wheel arm 2) can be inclined according to the need in a fixed manner, and the ability to adjust, at the same time through the use of springs, the amount of support that the wheels themselves must provide during operation.

In a first embodiment, for example shown in FIG. 1 and in FIGS. 1a to 1c, the variable-attitude system comprises a frame arm 1 anchorable to the frame of the two-wheeled vehicle (for example by fixing screws) and a wheel arm 2 suitable to support the stabiliser wheel 3. The frame arm 1 and the wheel arm 2, preferably made of metal, are pivotally connected to each other by means of a hinge joint, so as to enable rotation of the wheel arm 2 relative to the frame arm 1 around the rotation axis X, preferably parallel to the running plane of the wheel. The variable-attitude system also comprises elastic means, joined to the wheel arm 2 and the frame arm 1, suitable to adjust the elastic force between the two arms 1 and 2. Preferably, the elastic means are disposed around the rotation axis X (i.e., around the joint 5) and, for example, comprise a single or double torsion spring (for example, shown in FIG. 1) arranged in such a way that the axis of the coils of the spring is parallel to the rotation axis X.

On the two sides of one of the two arms 1 or 2, for example on the sides of the frame arm 1, there are holes 4, preferably arranged spaced apart in a row in a vertical direction Y perpendicular to the running plane 12. The holes 4 are suitable to allow the gradual shift of at least one stop pin 6, 20 with spheres or cotter or screw pin, insertable in the holes 4 to gradually raise the wheel from the running plane.

Preferably, on each of the sides of the frame arm 1, is formed a respective vertical flange 100 and 101, which extends on a plane perpendicular to the running plane 12 and on which there are formed the holes 4.

The excursion of the wheel arm 2 is controlled by acting on an upper pin stop 20 and a lower pin stop 6 with spheres or cotter or screw pins. It therefore possible to hold the arm 2 stopped in different pre-selected positions:

a) position of maximum support to the inclinations of the child (shown in FIG. 1) by the wheel, in which the wheel is fixed and in contact with the running plane;

b) position of intermediate support (shown in FIG. 1b), in which the wheel arm is kept fixed in an inclined position by at least two pin stops 6 and 20 and the wheel is partially raised with respect to the running plane 12.

Furthermore, this embodiment allows adjusting the oscillation of the bicycle, or mini motorbike, during running, as a function of the dexterity of the child, gradually shifting, from hole to hole, only the upper stop pin 20 with spheres or cotter or screw pin, to that the wheel arm 2 oscillates freely (as, for example, shown in FIG. 1a), between a lower limit position (wheel arm 2 lies on the lower stop pin 6) and an upper limit position (wheel arm 2 in contact at the top with the upper stop pin 20). Thus, both stop pins 6 and 20 respectively limit the oscillation of the wheel arm 2 below and above.

Additionally, by positioning both pins with spheres or cotter or screw pins 6 and 20 below the adjustable arm 2, it is possible to hold the wheel in the fully raised position (such as shown in FIG. 1c), at the time when the child achieves the maximum riding dexterity and with consequent permanent removal of the riding support.

In a second variant (shown for example in FIGS. 1d, 2, 3 and 6) where the elastic means are constituted by a double torsion spring 8, there is a threaded-screw adjusting pin 7. This adjusting pin is anchored, at the top, to the joint 5 by means of the anchoring support 9 provided with slots 13; these show the position of the ends of the spring 8 to establish the degree of pressure of the spring on the arm 2 (wheel arm). At the base, the adjusting pin 7 is anchored to the arm 2 (wheel arm) using an anchoring hole 10 (FIG. 1d).

By acting on the adjusting pin 7, it is possible to increase or decrease the pressure of the double torsion spring 8 on the arm 2 (wheel arm). This through the aid of the threaded support 11 (FIG. 1d), specially designed, that slides upwards to increase the pressure (FIG. 2) and downwards to decrease it (FIG. 3), guided by the threading on the adjusting pin 7. The support 11, by moving the arms of the double torsion spring 8 upwards and downwards as needed, facilitates the calibration of the pressure exerted by it on the arm 2 (wheel arm) and adjusts the adhesion of the wheel 3 to the running plane 12. This, therefore, allows modulating the support provided by the wheels, as a function of the ability gradually acquired by the child. The adjustable inclination of the arm 2 (wheel arm), which supports the wheel 3, from the beginning, allows using the bicycle or mini motorbike correctly in curves that, in this case, can take place by leaning and shifting the weight towards the trajectory of the curve, something that traditional blocked wheels do not allow. This inclination, supported by the adjustable force of the double torsion spring 8, also allows safety learning to put the foot down, which is necessary in the case of stopping or excessive inclination, to prevent ruinous falls.

In a third version (illustrated for example in FIGS. 4, 5 and 7), the system for adjusting the pressure of the wheel 3 on the running plane 12 innovatively uses a compression spring integrated in an adjustment bellows 14 and anchored to the semi-rigid plastic of which it is composed. Similarly, to the adjustment bellows 14 is anchored a threaded metal nut 15 so as to constitute, as well, a single block (threaded nut, spring and bellows) used entirely as an adjustment support 14 screwed onto the threaded pin 19 (FIG. 4).

The threaded pin 19, where the threaded nut 15 slides to adjust the excursion of the adjustment bellows 14, is secured at the base to the screw of the joint 5 by means of a movable support 16, which allows it to oscillate integrally with the arm 2 (wheel arm), and anchored to the arms 1 and 2 (frame arm and wheel arm) by means of two arm segments 17 (lateral segments) that, in turn, connect to a support 18 (sliding support) that, sliding along the threaded adjusting pin 19, allows the adjustment of the pressure of the spring of the bellows 14 on the arm 2 (wheel arm), (FIG. 4) less pressure, and (FIG. 5) more pressure.

The possibility of having the arm 2 (wheel arm), which houses the wheel 3, inclinable, in the manner described, also allows making more comfortable, easy and progressive the total elimination of the stabiliser wheels at the end of learning. To do so, in the first, second and third version described above, it is sufficient to act on the metal pin stop with spheres or cotter or screw pin 6 placed under the arm 2 (wheel arm) and inserted in the holes 4 on the arm 1 (frame arm). When the dexterity achieved by the child is such as to allow the minimum pressure of the elastic means on the arm 2 (wheel arm) with the adjustment of the threaded pin 7 (FIG. 3), in the second version by acting on the double torsion spring 8, and with the rotation of the adjustment bellows 14 (FIG. 4), in the third version by loosening the compression spring, it is possible to remove the wheels by gradually raising them. In this system, this can take place simply by progressively moving in the holes 4 on the arm 1 (arm frame) the metal stop pin with spheres or cotter or screw pin 6, as shown for example in FIG. 1c, for the first version, (FIG. 6) for the second version, and (FIG. 7) in the third version with adjustment bellows 14. This gives the child the opportunity to gradually get used to the total absence of support provided by the wheels. This support remains available until final elimination for any excessively accentuated lateral inclinations that could lead to certain falls in the absence of the wheels, even if raised.

Innovatively, the variable-attitude system applicable to stabiliser wheels according to this invention, allows the operator to adapt the behaviour of the system to the riding characteristics of the child that gradually change as his/her riding dexterity improves. In fact, it is possible to arbitrarily adjust the amount of the excursion that the mechanical arm can make by shifting one or more pins inserted in the plurality of holes made on the sides of one of the arms, for example on the frame arm.

In addition, according to the embodiments of the invention described above, the system allows both gradually raising the wheel from the running plane by means of the adjustment holes 4 and at the same time allows adjusting the elastic force between the frame arm 1 and the wheel arm 2, for example by positioning of the upper stop 20 and the lower stop 6, or by means of the threaded-screw adjusting pin 7 or through the bellows adjustment support 14 together with compression spring and threaded nut 15 integrated in it.

Advantageously, the presence of an interlocking support of the ends of the double torsion spring on the adjusting pin allows facilitating the operations of adjusting the pressure of the spring on the arm.

Still advantageously, in an embodiment variant, the presence of a bellows adjustment support, complete with integrated compression spring and threaded nut, and a second sliding support, allows a finer and easier to implement adjustment of the pressure of the spring on the wheel arm.

The stabiliser wheels provided with the system according to this invention allow the child to learn to ride a bicycle or mini motorbike correctly while having fun right from the start. With this system, learning takes place gradually and more quickly, with greater safety for the child and in a way that is more practical and less fatiguing for the parents. The mechanism described allows progressively reducing the balance support provided by the supplementary wheels by adjusting the pressure of a spring. In this way, dexterity in the use of the bicycle or mini motorbike is acquired in an instinctive and natural way. This also takes place in complete safety since the support of the spring is such as to give the child time, in the event of excessive inclination of the bicycle or mini motorbike, to rest the foot on the ground. Also, the wheels can be eliminated, much earlier and gradually, by moving upwards a stop pin or a screw pin that raises the arm that supports them, moving them progressively away from the running plane

It is clear that one skilled in the art, in order to meet contingent needs, may make changes to the invention described above, all contained within the scope of protection defined by the following claims.

1-15. (canceled)

16. A variable-attitude system, applicable to children's bicycles or mini motorbikes having a frame, comprising:
a frame arm to be anchored to the frame of the children's bicycle or mini motorbike;
a wheel arm for supporting a stabilizing wheel of the children's bicycle or mini motorbike;
an elastic hinge joint interposed between the frame arm and the wheel arm and operatively connected therewith to allow mutual elastic rotation thereof about a rotation axis;
a lower stop pin;
an upper stop pin, wherein the frame arm includes an adjusting portion comprising a plurality of superimposed adjustment holes to be removably engaged by the lower stop pin and the upper stop pin; and wherein the wheel arm is interposed between the lower stop pin and the upper stop pin to selectively come in contact therewith, so that the lower stop pin and the upper stop pin respectively define an upper limit position and a lower limit position of the wheel arm to be adjusted by a user by repositioning the lower stop pin and the upper stop pin through the adjustment holes.

17. System according to claim 16, wherein the frame arm includes an anchoring portion comprising an anchoring element for the anchoring to the frame of the children's bicycle or mini motorbike, the anchoring portion defining a first axis perpendicular to the rotation axis.

18. System according to claim 17, wherein the wheel arm defines a second axis perpendicular to the rotation axis, the frame arm and the wheel arm mutually rotating in a plane defined by the first axis and the second axis and perpendicular to the rotation axis.

19. System according to claim 18, wherein the adjusting portion defines a third axis parallel to the first axis, the adjusting holes laying along the third axis.

20. System according to claim 19, wherein the frame aim further includes a connecting portion defining a fourth axis perpendicular to the first axis and to the third axis, the connecting portion being interposed between the anchoring portion and the adjusting portion for mutually connecting thereof.

21. System according to claim 16, wherein the elastic hinge joint comprises a double torsion spring acting on the frame arm and on the wheel arm.

22. System according to claim 21, wherein the frame arm and the wheel aim are joined by a threaded-screw adjusting pin provided with a threaded support, said threaded-screw adjusting pin being anchored to the joint by means of an anchoring support and to the wheel arm through an anchoring hole.

23. System according to claim 22, wherein the threaded-screw adjusting pin is suitable to allow the modulation of the pressure of the double torsion spring on the wheel arm, by varying the distance of the two ends of said spring from the surface of the wheel arm.

24. System according to claim 23, wherein, on the threaded-screw adjusting pin, there is a specially designed support that allows an interlocking support of the ends of the double torsion spring to facilitate an excursion upwards, to increase the pressure of the spring on the wheel arm, and downwards upon the decrease of the pressure of the spring on the wheel arm.

25. System according to claim 24, wherein the anchoring support is suitable to stabilise the vertical position of the threaded-screw adjusting pin, anchoring it to the joint.

26. System according to claim 16, wherein the stabilizing wheel runs on a running plane, further wherein for adjusting the pressure of the wheel on the running plane, a bellows adjustment support is operated complete with compression spring and threaded nut integrated into it.

27. System according to claim 26, wherein there is a threaded adjustment pin that allows an excursion of the bellows adjustment support.

28. System according to claim 27, wherein, on the threaded adjustment pin, there is a second support that, sliding along the pin, allows adjustment of the pressure on the wheel arm.

29. System according to claim 28, wherein there are two arm segments that provide support to the arms.

30. System according to claim 29, wherein there is a mobile support that, at the base, secures the threaded adjusting pin to the joint allowing it to oscillate integrally with the arm.
